(19) United States
(12) Patent Application Publication
(10) Pub. No.: US 2011/0125577 A1
(43) Pub. Date: May 26, 2011

(54) SYSTEM AND METHOD FOR MONETIZING WEB ADS BASED ON ENGAGEMENT

(76) Inventors: Paxton Song, Los Altos, CA (US); Arnaud Tellier, Sunnyvale, CA (US)

(21) Appl. No.: 12/950,873

(22) Filed: Nov. 19, 2010

Related U.S. Application Data
(60) Provisional application No. 61/263,366, filed on Nov. 21, 2009.

(51) Int. Cl. G06Q 30/00

(52) U.S. Cl. 705/14.53; 705/14.66

(57) ABSTRACT

In a method and system for delivering and monitoring web-based ads, a request is received for an advertisement to be displayed in a webpage. An advertisement is generated based on tracking data and user profile data. The tracking data identifies a consumer computer system accessing the webpage. At least one engagement event between the consumer computer system and the advertisement is recorded. An amount owed by an advertiser associated with the advertisement for the at least one engagement event is calculated using a dynamic pricing model. The amount owed is based on a type of the at least one engagement event.

### CROSS-REFERENCE TO RELATED APPLICATIONS

This application claims the benefit of U.S. Provisional Patent Application Ser. No. 61/263,366 filed Nov. 21, 2009, (“METHOD FOR MONETIZING WEB ADS BASED ON ENGAGEMENT”), which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright© 2009, Veruta All Rights Reserved.

### TECHNICAL FIELD

Aspects of the present disclosure relate generally to Internet advertising, and more specifically, to a system and method to monetize a dynamic web ad by charging the advertiser based on a user's engagement with the ad.

### BACKGROUND

One of the primary forms of web advertising is through banner advertisements (ads). Banner ads typically appear at or near the top of a web page. The banner ads can be delivered by an ad server that tracks the individual deliveries of the banner ads, thereby monitoring the reach of particular web advertising campaigns. The banner ads also represent a link to the advertiser's site, which can be reached by clicking on the banner ad.

Banner ad packages are typically sold on a cost per thousand impressions basis. An impression or page view occurs when a visitor to a web site views a page where a banner ad is displayed. The prices of the banner ad packages are typically based on the number of clicks, often measured in a price per thousand impressions. Alternatively, banner ad packages may be sold on a cost per click basis. A click occurs when a visitor to a web site clicks on the banner ad.

### BRIEF DESCRIPTION OF DRAWINGS

Some embodiments are illustrated by way of example and not limitation in the figures of the accompanying drawings in which:

FIG. 1 is a block diagram illustrating an advertisement billing system, according to an example embodiment.

FIG. 2 is a diagrammatic representation of a dynamic ad server, as may be used in an example embodiment.

FIG. 3 is a diagrammatic representation of a suitable layout for a dynamic web page ad, as may be used in an example embodiment.

FIG. 4 is a flow chart illustrating a method to monetize a dynamic web ad by charging the advertiser based on a user's engagement with the ad, according to an example embodiment.

FIG. 5 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

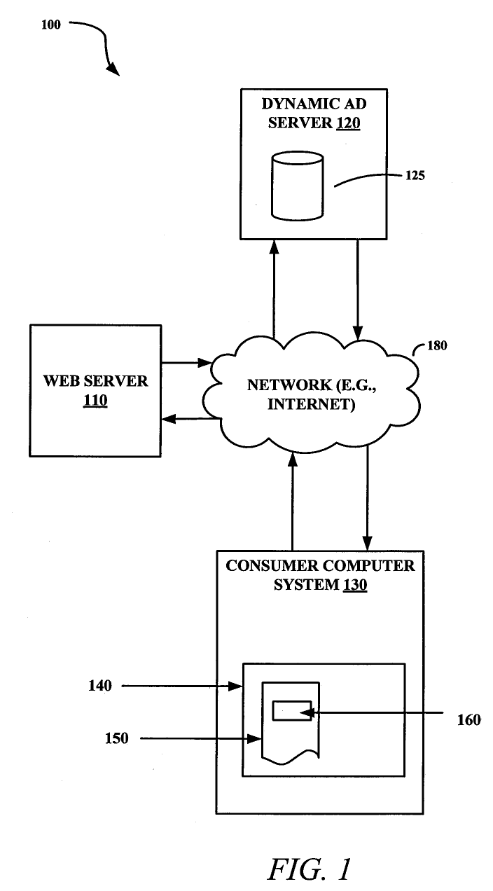

One example of an advertisement billing system 100 is illustrated in FIG. 1. The advertisement billing system 100 includes web server 110, dynamic ad server 120, and user computer system 130. As shown in FIG. 1, the web server 110, the dynamic ad server 120, and the user computer system 130 are coupled to each other via a wide area network, e.g., the Internet 180.

As shown, the user computer system 130 includes a web browser 140 for traversing web content 150. FIG. 1 shows that the web content 150 includes an advertisement unit 160 that requests a dynamic ad server 120 to provide static or dynamic web ads. In an example embodiment, a dynamic ad may include interactive features and functionalities that enable a user to interact with the various aspects of the advertisement without necessarily being re-directed to a third party webpage (e.g., the advertiser's website). Further, the dynamic ad server 120 is shown to include an engagement database 125. Engagement database 125 may store user profile information associated with a user. User profile information may include but is not limited to data related to a user's interaction with a webpage or an advertisement and data that may imply or express an interest by the user in content (e.g., a product, a service, a brand) displayed in the advertisement. The user profile information may further include tracking data (e.g., a cookie) that identifies a computing device used by a user. The tracking data may be stored and associated with the user profile information.

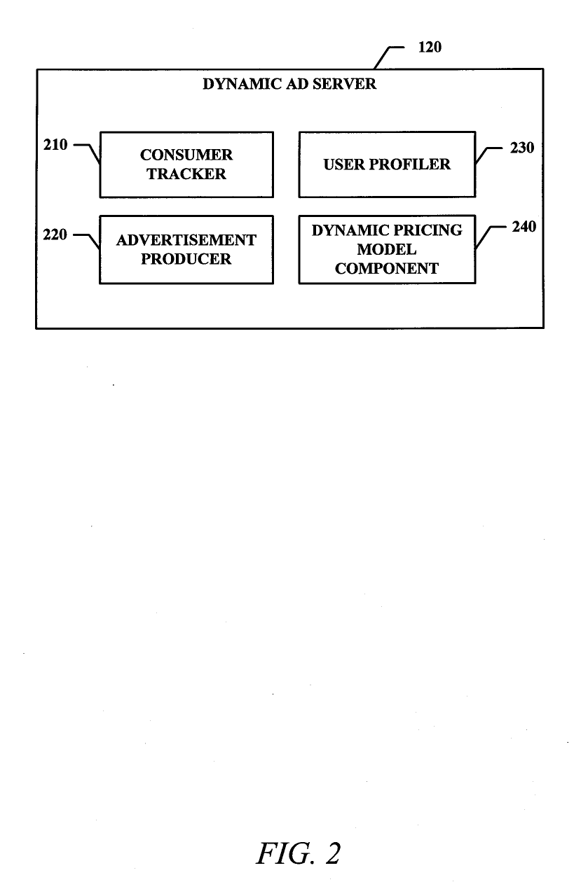

Referring now to FIG. 2, the dynamic ad server 120 includes a consumer tracker 210, an advertisement producer 220, a user profiler 230, and a dynamic pricing model component 240. Each of the consumer tracker 210, the advertisement producer 220, the user profiler 230, and the dynamic pricing model component 240 may be implemented by one or more processors of the dynamic ad server 120.

In an example embodiment, the consumer tracker 210 is configured to create and associate tracking data with the consumer computer system 130. When the browser 140 traverses the web content 150, the browser 140 may transmit merchant product data displayed as part of the web content 150 to the dynamic ad server 120. At the same time, the browser 140 may also transmit the tracking data, if available. In the event the tracking data is not available (e.g., the tracking data has been deleted), the consumer tracker 210 may create the tracking data and transmit the tracking data to the consumer computer system 130. Additionally, once the tracking data is created, the consumer tracker 210 may store the tracking data 130, for example, in the engagement database 125.

In an example embodiment, the consumer tracker 210 may transmit the tracking data to the consumer computer system 130 in the form of a cookie. As such, the cookie transmitted in the request headers will identify a consumer using the consumer computer system 130. In another example embodiment, the tracking data may be transmitted to the dynamic ad server 120 directly in the URL for the request.

The user profiler 230 is configured to receive the merchant product data and the tracking data, which the browser 140 transmits when traversing the web content 150. In response to receiving the merchant product data and the tracking data, the user profiler 230 updates the user profile data stored in the engagement database.

In an example embodiment, the user profiler 230 may record user profile data including engagement events related to a consumer browsing activities with respect to the merchant content. For example, the user profile data may include the number of times merchant product data was viewed, the number of times merchant product data was bought, the number of time merchant product data was added to the cart, the number of times merchant product data was searched. User profile data also may include user browsing behavioral data, such as the amount of time a user spends on a certain web page, the web page elements that a user interacts with via a user input device, and the amount of time that a user spends interacting with a web page element.

The engagement events included in the user profile data may include any type of engagement between the consumer computer system 130 and the web content 150 or an advertisement displayed with or in the web content 150. Engagement event types may include but are not limited to time-over events, scroll events, click events, and mouse over events. Engagement events may comprise interaction between the consumer computer system and the web content 150 or advertisement(s) in a manner that does not cause the browser 140 to be re-directed to another webpage. For example, engagement events may include interaction with one or more interactive elements (e.g., selectable buttons, menus, content) of an advertisement. Engagement events also may include events (e.g., a click-through) that cause the browser 140 to be re-directed to a different webpage.

The advertisement producer 220 is configured to create dynamic product advertisements based on a combination of one or more of user identifier data, user profile data, and inventory data related to merchant content viewed by the consumer computer system 130. The following exemplary steps are provided to illustrate how the advertisement producer 220 creates dynamic advertisements. First, the browser 140 traverses the web content 150. In response to being rendered by the browser 140, the web content 150 directs the browser 140 to transmit certain merchant product data displayed as part of the web content 150 and the tracking data to the dynamic ad server 120. The dynamic ad server 120 receives the merchant product data and tracking data pair and stores this information with the user profile data, and according to an example embodiment, in the engagement database 125. At a later point in time, the browser 130 may traverse the web content 150, which includes the advertisement unit 160. To render the advertisement unit 160, the browser may request content from the dynamic ad server 120. At this point, the advertisement producer 220 may query the engagement database 120 for the recorded browsing activities that match the tracking data.

The dynamic pricing model component 240 is configured to determine an amount to charge a merchant or advertiser for delivery of the generated advertisement to the consumer computer system 130 and engagement of the advertisement by the consumer computer system 130. In an example embodiment, the dynamic pricing model component 240 may charge a fixed amount for each engagement event between the consumer computer system 130 and the advertisement. In an example embodiment, the dynamic pricing model component 240 may charge the advertiser a varying amount per engagement based on one or more factors. The factors may include the performance of the advertisement, such as the popularity of the advertisement (as reflected by the click-through rate or the engagement rate of the ad), and the volume of the ad (e.g., the number of ad impressions or deliveries purchased by the advertiser). In an example embodiment, the dynamic ad server 120 can charge a fee only once per banner, once per type of event, or after the users engaged a given amount of times or for every engagement. In an example embodiment, the fee could be dynamically calculated depending on the user profile data, the web ad shown, products shown, type of engagement, number of times the engagement happens, and how long and how soon that engagement happened.

In an example embodiment, the dynamic pricing model component 240 may calculate a variable amount owed by an advertiser based on the type of recorded engagement. For example, the advertiser may be charged more for an engagement in which a user interacts with a product displayed in the ad than if a user merely mouses over the ad for a period of time because an interaction with a product displayed in the ad may express user interest in the product and the ad more than a mouse over of the ad. Thus, the dynamic pricing model component 240 may charge varying amounts for different engagement events to reflect that the different engagement events may indicate varying levels of user interest in the ad or the content of the ad.

In an example embodiment, the dynamic pricing model component 240 may charge different amounts for an engagement event based on the time of the engagement event. For example, if a user engages a displayed ad at night, the dynamic pricing model component 240 may charge the advertiser less than if the user engaged the displayed ad during the day. In an example embodiment, the dynamic pricing model component 240 also may charge varying amounts for an engagement model based on the day of the week of the engagement event.

In another example embodiment, the dynamic pricing model component 240 may not charge or debit an advertiser immediately upon the occurrence of an engagement event. Instead, the dynamic pricing model component 240 may log or note the user engagement event with the advertisement. If the user later returns to a site associated with the advertisement within a predetermined period of time, the dynamic pricing model component 240 may record the user visit (via the tracking data contained on a computer system associated with the user) and attribute the visit to the previously logged engagement event. Upon this attribution, the dynamic pricing model component 240 may charge the advertiser for the previously logged engagement event.

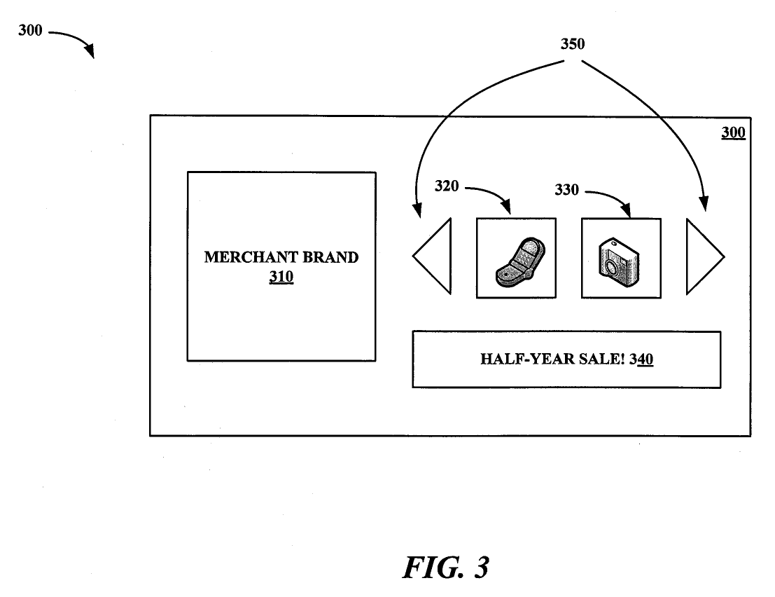

FIG. 3 illustrates one suitable layout for a dynamic ad 300. As shown, the dynamic ad 300 includes six web elements. The design of the dynamic ad 300 can be varied as desired. FIG. 3 is intended only to be exemplary of one possible layout; many other layouts exist as would be appreciated by those skilled in the art.

The dynamic ad includes a brand area 310, product areas 320 and 330, and informational area 340. As depicted, the dynamic ad 300 further includes interactive buttons 350. The brand area 310 displays a brand name to indicate the source of the advertiser, such as a merchant. Product areas 320 and 330 display products offered for sale by the advertiser displayed in brand area 310. The interactive buttons 350 provide functionality to the dynamic ad 300. In an example embodiment, the interactive buttons 350 will replace the products shown in 320 or 330 with new product displays. The informational area 340 may display promotional deals, descriptions, or other similar information.

As just described, the dynamic ad 300 includes web elements (310, 320, 330, 340, 350) that can change, in response to different contexts or conditions. For example, the interactive buttons 350 allow the user operating web browser 140 to scroll new products into product display areas 320 and 330. In an example embodiment, client-side scripting is used to enable dynamic ad behavior in response to, for example, mouse or keyboard actions or at specified timing events. As is appreciated in the art, client-side scripting can include languages like JavaScript or ActionScript, used for Dynamic HTML (DHTML) and Flash technologies respectively, or other suitable scripting languages. Client-side scripting also allows use of remote scripting, a technique by which the dynamic ad requests additional information from a server, using, for example, a hidden frame, XMLHttpRequests, or a Web service.

In another example embodiment, the dynamic ad 300 may utilize server-side scripting to provide web page functionality, such as PHP, Perl, ASP, ASP.NET, JSP, ColdFusion and other languages.

In an example embodiment, the dynamic ad 300 may also include one or more of the following: a static area, tabs, drop-down menus, product panels, product links, form elements (e.g., checkboxes, radio buttons, links, buttons, text input boxes, email input boxes), titles, descriptions, and prices. One more of these elements may be interactive elements.

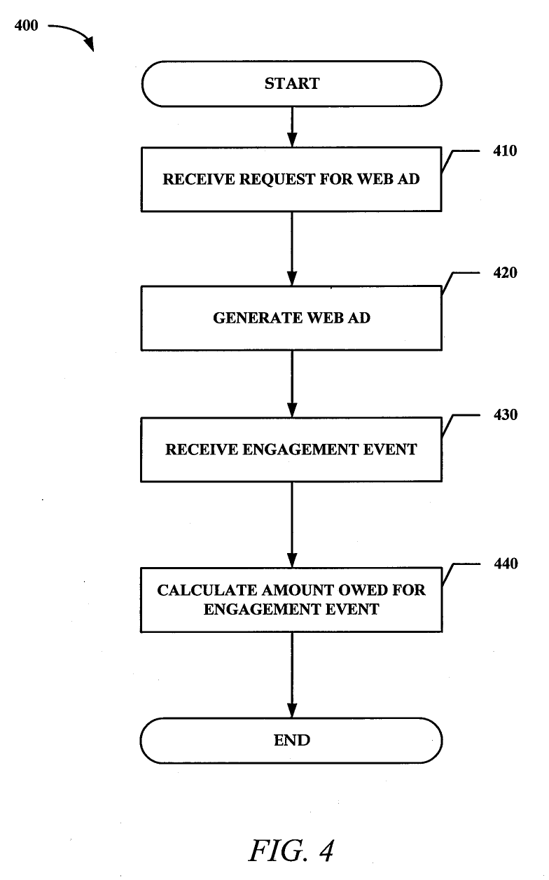

FIG. 4 is a flow chart illustrating a method 400, in accordance with an example embodiment, to monetize a web ad by charging the advertiser based on the engagement of the user with respect to the advertisement unit 160. The method 400 may be performed by any of the modules, logic, or components described herein.

The method 400 commences at operation 410 with the dynamic ad server 120 receiving a request for a static or dynamic ad to be displayed in the area of the web page 150 indicated by the advertisement unit 160. In an example embodiment, the dynamic ad server 120 receives the request for dynamic ad from the web browser 140 loading the web page 150, which embeds the advertisement unit 160. In this example embodiment, the advertisement unit 160 identifies the dynamic ad server 120 as the source for the dynamic ad. In an example embodiment, the advertisement unit 160 includes an HTML image pointer tag that identifies the dynamic ad server 120 as the source of the dynamic ad.

In an example embodiment, dynamic ad server 120 may receive identification data from the user computer system 130 that uniquely identifies user computer system 130 as the requester of the web ad.

In operation 420, dynamic ad server 120 generates the dynamic ad to be displayed by the web browser 150 of the user computer system 130 and sends the dynamic ad to user computer system 130. As can be appreciated by those skilled in the art, the dynamic ad server 120 can be configured to generate dynamic ad in the various formats capable of display by the web browser 150, including the client- and server-side scripting previously described.

In an example embodiment, the dynamic ad server 120 can generate the web ad based in part on the user profile stored in the engagement database 125. Specifically, the dynamic ad server 120 may query engagement database 125 for previously recorded information corresponding to user computer system 130. The following operations describe in more detail the type of information that can constitute a user profile stored in the engagement database 125.

In operation 430, dynamic ad server 120 receives engagement events from the web browser 140 and records the events in the engagement event database 125. Engagement events relate to the type of interactions the user operating the web browser 140 has with the advertisement unit 160. In an example embodiment, dynamic ad server 120 receives engagement events via a cookie stored in web browser 140. In another example embodiment, user computer system 130 may send engagement events directly to the dynamic ad server 120. In yet another example embodiment, the user computer system 130 sends tracking data (for example, a cookie) that uniquely identifies the user computer system 130 and, as a result, dynamic ad server 120 can associate the engagement events with the user computer system 130. Associating the engagement event with the tracking data allows the dynamic ad server to create a user profile of the user computer system 130.

Dynamic ad server 120 may store various types of engagement events in engagement database 125. By way of example and not limitation, the types of engagement events include time-over events, scroll events, click events, and mouse over events. Generally speaking, an engagement event may be any measurable interest displayed by a user in an advertisement.

Time-over events specify the amount of time the user places the computer cursor over the dynamic ad unit 160, or portions thereof. One or more time-over events may be simultaneously tracked. For example, a first time-over event corresponding to the amount of time a computer cursor is placed on an ad may be tracked at the same time as a second time-over event corresponding to the amount of time a computer cursor is placed on a specific element in the ad. The time-over events may overlap but vary in duration due to the computer cursor staying within the ad but moving to a different ad element.

A scroll event may represent whether the user engages in interactive features of the dynamic ad. For example, a user may activate interactive buttons 350 of the dynamic ad 300 that advance a scroll list and places new products in product areas 320 and 330. New products 320 and 330 may be selected based on stored user profile information, including recorded product interest information.

Dynamic ad server 120 may record click events. Click events represent the user clicking on a link, a button, a tab, a drop-down menu, or a clickable part of the dynamic ad. In some example embodiments, a click leads to a landing page on another site or server (such as a link to the actual product on our merchant's website).

In yet another example embodiment, the dynamic ad server 120 may record mouse over events. Mouse over events indicate that the user cursor was placed over an element of the dynamic ad 300 (e.g., image, link, price, description, discount sticker) and remained over the element for a specified time (five seconds, for example). In an example embodiment, a mouse over event may not be recorded unless its duration exceeds a predetermined amount of time. Exclusion of mouse over events of a shorter duration than the predetermined amount of time may eliminate false positives, such as a fly by event in which a user happens to move a computer cursor over an ad element on the way to a different portion of the display.

The above-described engagement events indicate that the dynamic ad 300 has generated interest from the user. As a result, the dynamic ad server 120, in some example embodiments, can serve the same or similar dynamic ad to the user computer system 130 in the future.

In operation 440, the dynamic ad server 120 calculates the amount the advertiser owes for the web ads served to the user by the dynamic ad server 120 based on a pricing model. In an example embodiment, the pricing model may be a fixed pricing model, in which the advertiser is charged a fixed amount for each engagement event with a rendered ad. In an example embodiment, the pricing model may be a dynamic pricing model, in which the advertiser is charged a varying amount per engagement based on one or more factors. The factors may include the performance of the advertisement, such as the popularity of the advertisement (as reflected by the click-through rate or the engagement rate of the ad), and the volume of the ad (e.g., the number of ad impressions or deliveries purchased by the advertiser). In an example embodiment, the dynamic ad server 120 can charge a fee only once per banner, once per type of event, or after the users engaged a given amount of times or for every engagement. In an example embodiment, the fee could be dynamically calculated depending on the user profile data, the web ad shown, products shown, type of engagement, number of times the engagement happens, and how long and how soon that engagement happened.

In an example embodiment, the dynamic pricing model may charge an advertiser a varying amount per engagement based on the type of recorded engagement. For example, the advertiser may be charged more for an engagement in which a user interacts with a product displayed in the ad than if a user merely mouses over the ad for a period of time because an interaction with a product displayed in the ad may express user interest in the product and the ad more than a mouse over of the ad. Thus, the dynamic pricing model may charge varying amounts for different engagement events to reflect that the different engagement events may indicate varying levels of user interest in the ad or the content of the ad.

In an example embodiment, the dynamic pricing model may charge different amounts for an engagement event based on the time of the engagement event. For example, if a user engages a displayed ad at night, the dynamic pricing model may charge the advertiser less than if the user engaged the displayed ad during the day. In an example embodiment, the dynamic pricing model also may charge varying amounts for an engagement model based on the day of the week of the engagement event.

In another example embodiment, the dynamic pricing model may not charge or debit an advertiser immediately upon the occurrence of an engagement event. Instead, the dynamic pricing model may log or note the user engagement event with the advertisement. If the user later returns to a site associated with the advertisement within a predetermined period of time, the dynamic pricing model may record the user visit (via the tracking data contained on a computer system associated with the user) and attribute the visit to the previously logged engagement event. Upon this attribution, the dynamic pricing model may charge the advertiser for the previously logged engagement event.

Dynamic engagement pricing also may be calculated based on the user profile information, such as the number of times the user has engaged with an advertisement or advertiser, the number of times the user visited to a site associated with an advertiser, the number of ads previously seen by the user, the level of interest expressed by a user in advertiser content or ads, and a calculated monetary value associated with the user. The calculated monetary value associated with the user may reflect a worth attributed to the user by the advertiser.

In this way, the dynamic pricing model is a charging model that is tailored to performance-oriented advertisers that still recognize the value of branding. The dynamic pricing model may implement a pricing scheme between that of a CostPerThousand (CPM) model and a CostPerClick (CPC) model. The dynamic pricing model may account for brand value, as well as recognize the value of performance. One feature of the dynamic pricing model is that it assures the advertiser that the user saw the web ad and comforts the advertiser that the web ad generated user interest, thereby allowing the advertiser brand name to stay in the mind of the user. Thus, the web ad can indicate interest in that product (i.e., mousing over the product could show the price or description or discount, and thus qualify interest) by providing dynamic ad server 120 engagement events.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

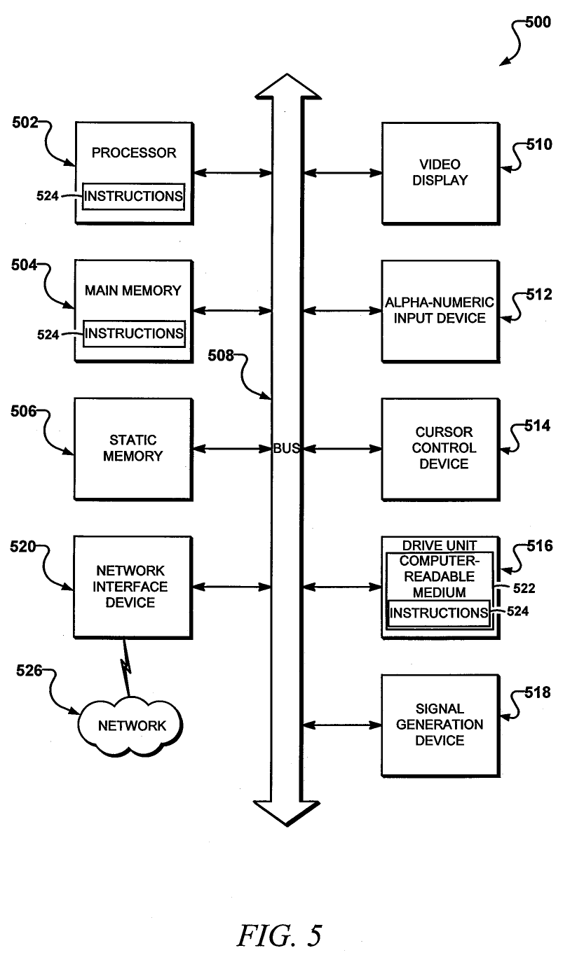

FIG. 5 is a block diagram of machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

### Machine-Readable Medium

The disk drive unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 524 may further be transmitted or received over a communications network 526 using a transmission medium. The instructions 524 may be transmitted using the network interface device 520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method, comprising:
receiving a request for an advertisement to be displayed in a webpage;
generating, by a processor, an advertisement based on tracking data and user profile data, the tracking data identifying a consumer computer system accessing the webpage;
recording at least one engagement event between the consumer computer system and the advertisement;
calculating, by a processor implementing a dynamic pricing model, an amount owed by an advertiser associated with the advertisement for the at least one engagement event, the amount owed based on a type of the at least one engagement event.

2. The computer-implemented method of claim 1, wherein the user profile data comprises data representing user interest in advertiser content and prior engagement events recorded between the consumer computer system and previously displayed advertisements.

3. The computer-implemented method of claim 1, wherein the amount owed is further based on a time of the at least one engagement event.

4. The computer-implemented method of claim 1, wherein the amount owed is further based on the user profile data.

5. The computer-implemented method of claim 1, wherein the amount owed is further based on a performance of the advertisement.

6. The computer-implemented method of claim 5, wherein the performance of the advertisement is determined based on at least one of a click-through rate associated with the advertisement, a rate of engagement with the advertisement, and a volume of purchases of the advertisement.

7. The computer-implemented method of claim 1, wherein the type of the at least one engagement event includes a time-over event, a scroll event, a click event, and a mouse over event.

8. The computer-implemented method of claim 1, further comprising charging the advertiser the amount owed for the at least one engagement event upon occurrence of the at least one engagement event.

9. The computer-implemented method of claim 1, further comprising:
responsive to the recorded at least one engagement event, tracking a visit by the consumer computer system to a webpage associated with content displayed in the advertisement within a predetermined period of time; and
charging the advertiser the amount owed for the at least one engagement event upon occurrence of the tracked visit.

10. A non-transitory machine-readable medium storing a set of instructions that, when executed by a processor, causes the processor to perform operations, comprising:
receiving a request for an advertisement to be displayed in a webpage;
generating, by a processor, an advertisement based on tracking data and user profile data, the tracking data identifying a consumer computer system accessing the webpage;
recording at least one engagement event between the consumer computer system and the advertisement;
calculating, by a processor implementing a dynamic pricing model, an amount owed by an advertiser associated with the advertisement for the at least one engagement event, the amount owed based on a type of the at least one engagement event.

11. The non-transitory machine-readable medium of claim 10, wherein the user profile data comprises data representing user interest in merchant content and prior engagement events recorded between the consumer computer system and previously displayed advertisements.

12. The non-transitory machine-readable medium of claim 10, wherein the amount owed is further based on a time of the at least one engagement event.

13. The non-transitory machine-readable medium of claim 10, wherein the amount owed is further based on the user profile data.

14. The non-transitory machine-readable medium of claim 10, wherein the amount owed is further based on a performance of the advertisement.

15. The non-transitory machine-readable medium of claim 14, wherein the performance of the advertisement is determined based on at least one of a click-through rate associated with the advertisement, a rate of engagement with the advertisement, and a volume of purchases of the advertisement.

16. The non-transitory machine-readable medium of claim 10, wherein the type of the at least one engagement event includes a time-over event, a scroll event, a click event, and a mouse over event.

17. The non-transitory machine-readable medium of claim 10, further comprising charging the advertiser the amount owed for the at least one engagement event upon occurrence of the at least one engagement event.

18. The non-transitory machine-readable medium of claim 10, further comprising:
responsive to the recorded at least one engagement event, tracking a visit by the consumer computer system to a webpage associated with content displayed in the advertisement within a predetermined period of time; and
charging the advertiser the amount owed for the at least one engagement event upon occurrence of the tracked visit.

19. A system, comprising:
a processor-implemented dynamic advertisement producer configured to:
receive a request for an advertisement to be displayed in a webpage; and
generate an advertisement based on tracking data and user profile data, the tracking data identifying a consumer computer system accessing the webpage;
a processor-implemented user profiler configured to record at least one engagement event between the consumer computer system and the advertisement; and
a processor-implemented dynamic pricing model component configured to calculate an amount owed by an advertiser associated with the advertisement for the at least one engagement event, the amount owed based on a type of the at least one engagement event.

20. The system of claim 19, further comprising an engagement database to store the recorded at least one engagement event.

21. The system of claim 19, further comprising a processor-implemented consumer tracker configured to create the tracking data and to transmit the tracking data to a consumer computer system, the tracking data identifying the consumer computer system.

22. The system of claim 19, wherein the user profile data comprises data representing user interest in merchant content and prior engagement events recorded between the consumer computer system and previously displayed advertisements.

23. The system of claim 19, wherein the amount owed is further based on a time of the at least one engagement event.

24. The system of claim 19, wherein the amount owed is further based on the user profile data.

25. The system of claim 19, wherein the amount owed is further based on a performance of the advertisement.

26. The system of claim 25, wherein the performance of the advertisement is determined based on at least one of a click-through rate associated with the advertisement, a rate of engagement with the advertisement, and a volume of purchases of the advertisement.

27. The system of claim 19, wherein the type of the at least one engagement event includes a time-over event, a scroll event, a click event, and a mouse over event.

28. The system of claim 19, wherein the processor-implemented dynamic pricing model component is further configured to charge the advertiser the amount owed for the at least one engagement event upon occurrence of the at least one engagement event.

29. The system of claim 19, wherein the processor-implemented user profiler is further configured to responsive to the recorded at least one engagement event, track a visit by the consumer computer system to a webpage associated with content displayed in the advertisement within a predetermined period of time, and wherein the processor-implemented dynamic pricing model component is further configured to charge the advertiser the amount owed for the at least one engagement event upon occurrence of the tracked visit.
